(19) United States
(12) Patent Application Publication
(10) Pub. No.: US 2016/0124744 A1
(43) Pub. Date: May 5, 2016

(54) SUB-PACKAGING OF A PACKAGED APPLICATION INCLUDING SELECTION OF USER-INTERFACE ELEMENTS

(71) Applicant: EMPIRE TECHNOLOGY DEVELOPMENT LLC, Wilmington, DE (US)

(72) Inventor: Ezekiel Kruglick, Poway, CA (US)

(21) Appl. No.: 14/398,715

(22) PCT Filed: Apr. 3, 2014
(86) PCT No.: PCT/US14/32826

§ 371 Date: Nov. 3, 2014

(51) Int. Cl. G06F 9/44; G06F 9/445; G06F 3/0481; G06F 3/0482; G06F 3/0484

(52) U.S. Cl. CPC G06F 8/71; G06F 3/0482; G06F 3/04842; G06F 3/04817; G06F 8/65

(57) ABSTRACT

The present disclosure relates to methods and apparatuses for forming a packaged application based on a selected subset of user-interface elements. One example method includes receiving a selection of a subset of user-interface elements of a packaged application at a device, determining data of the packaged application associated with execution of the subset of user-interface elements, and packaging the data to form another packaged application for executing the subset of user-interface elements.

### BACKGROUND

Packaged applications generally refer to applications that include all assets and function calls needed for operation of the packaged application on top of host application executables, such as an Internet browser. Including all function calls in the packaged application may allow the packaged application to run offline or be transferred via a peer-to-peer connection to be run on a receiving device. Packaged applications may also be closely integrated with a user's operating system to allow the packaged application to appear as a normal application on a computing device (e.g., show up as an icon on a desktop).

The tools that are used to generate packaged applications may provide a packaged application that is distributed having complex connections of inter-related files. Thus, it is difficult to separate components of a packaged application into individual components that work across multiple devices and platforms.

### SUMMARY

Techniques are generally described that include methods and apparatuses. One example method may include receiving a selection of a subset of user-interface elements of a packaged application at a device. The example method may further include determining data of the packaged application associated with execution of the subset of user-interface elements. The example method may further include packaging the data to form another packaged application for executing the subset of user-interface elements.

Another example method may include receiving a selection of a user-interface element of a packaged application and packaging data associated with execution Of the user-interface element to provide another packaged application. The example method may further include transmitting the another packaged application to a device

One example apparatus may include a packaged application including user-interface elements and a sub-module generator configured to receive a selection of a subset of the user-interface elements. The sub-module generator of the example apparatus may be further configured to identify data of the packaged application associated with execution of the subset of user-interface elements and to generate another packaged application for execution of the selection of user-interface elements using the data.

The foregoing summary is illustrative only and is not intended to be in any way limiting, in addition to the illustrative aspects, embodiments, and features described above, further aspects, embodiments, and features will become apparent by reference to the drawings and the following, detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which

FIG. 1 is a schematic illustration of an apparatus including a sub-module generator configured to provide a packaged application;

FIG. 2 is a schematic illustration of a an apparatus including a sub-module generator configured to provide a packaged application;

FIG. 3 is a flowchart illustrating an example method for providing a second packaged application based on a selection of a subset of user-interface elements of a first packaged application;

FIG. 4 is a block diagram illustrating an example computing device that is arranged for providing a second packaged application based on a selection of a subset of user-interface elements of a first packaged application; and

FIG. 5 is a block diagram illustrating an example computer program product that is arranged to store instructions for providing a second packaged application based on a selection of a subset of user-interface elements of a first packaged application;

all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative examples described in the detailed description, drawings, and claims are not meant to be limiting. Other examples may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are implicitly contemplated herein.

This disclosure is drawn, inter alia, to methods, systems, products, devices, and/or apparatuses generally related to a packaged application including user-interface elements, and a sub-module generator that may be configured to receive a selection of a subset of the user-interface elements. In some examples, sub-module generator may further be configured to identify data of the packaged application associated with execution of the subset of user-interface elements, and to generate another packaged application for execution of the selection of user-interface elements using the data.

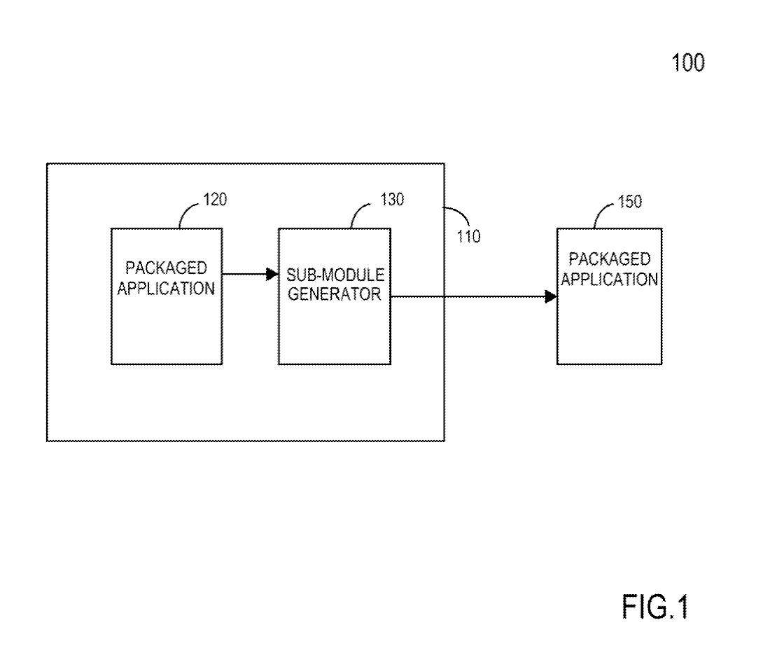

FIG. 1 is a schematic illustration of an apparatus 100 including a sub-module generator configured to provide a packaged application, arranged in accordance with at least some embodiments described herein. FIG. 1 depicts a device 110 that may include a first packaged application 120 and a sub-module generator 130. The sub-module generator 130 may provide a second packaged application 150 based on a received selection of a subset of user-interface elements of the first packaged application 120.

The device 110 may be implemented using any of a variety of devices, including but not limited to, a communications device, a personal digital assistant (PDA), a fixed location data unit, a mobile location data unit, a mobile phone, a cellular phone, a computer, a portable computer, a desktop computer, a monitor, a computer monitor, a television, a digital music player, a portable music player, a video player, a digital video player, or any other electronic device. The various components described in FIG. 1 are merely examples. and other variations, including eliminating components, combining components, and substituting components are all contemplated.

The first packaged application 120 may operate on designated host application executables and/or an underlying operating system platform of the device 110. In some examples, the first packaged application 120 may be a packaged web application that is designed to operate using web browser application executables. In some examples, the first packaged application 120 may be integrated with the operating system of the device 110. The first packaged application 120 may be designed to operate offline (e.g., with no connectivity to the Internet or other network) and/or online. The first packaged application 120 may include a manifest and code/resources. Resources may include libraries, shared functions, and other tools used by the code during execution. The manifest may designate permissions necessary to execute the first packaged application 120, such as host application executable permissions or underlying operating system permissions. Examples of permissions may include input/output (I/O) permissions (e.g., user interface devices, such as a mouse/keyboard, a camera, a printer, a speaker, a Bluetooth radio, a Universal Serial Bus (USB) port, etc.), display permissions (e.g., window), system permissions (e.g., file system, memory, power, location, diagnostics, identity, clipboard, etc.). The code and resources may also include data related to one or more user-interface element code entry points. For example, entry points may define where the code is entered when the first packaged application 120 is launched (e.g., opened), installed/uninstalled, or suspended (e.g., closed or shut down).

The sub-module generator 130 may receive a selected subset of user interface elements of the first packaged application 120. User interface elements generally refer to elements utilized to provide input to candor receive output from an application. Examples of user interface elements include, but are not limited to toolbars, buttons, text entry boxes, menus, and combinations thereof The selected subset of user interface elements may be received based on a selection by a user or from another computer process, in some examples. The sub-module generator 130 may identify data of the first packaged application 120 associated with execution of the selected subset of user-interface elements. The sub-module generator 130 may also use the data to generate the second packaged application 150. The second packaged application 150 may use the data to execute the selection of user-interface elements from the first packaged application 120. The selection of the user-interface elements may be received via an I/O component of the device 110. The data identified by the sub-module generator 130 may include access permissions, entry point data associated with one or more entry points, and code and resources associated with execution of the subset of user-interface elements.

In operation, the sub-module generator 130 may receive a selection of a subset of user-interface elements of the first packaged application 120 to be provided in a packaged application (e.g., the second packaged. application 150). The selected subset of user-interface elements may be received based on a selection by a user or from another computer process, in some examples. The sub-module generator 130 may identify data of the first packaged application 120 that is associated with execution of the subset of user-interface elements, and provide the second packaged application 150 based on the data. 1021 I In some examples, the second packaged application 150 may be provided to another device, and may run as a stand-alone packaged application. For example, the first packaged application 120 may include an audio player as part of a larger application. The sub-module generator 130 may identify data of the first packaged application 120 associated with execution of the audio player, and provide the second packaged application 150 using the identified data to allow the second packaged application 150 to execute the audio player on another device. In other examples, the second packaged application 150 may operate on another device and interface back via, a network (e.g., or other interface) connection to the device 110 to control aspects of the first packaged application 120. For example, the device 110 may be a television, and the selected subset of user-interface elements may include a toolbar of the first packaged application 120. The sub-module generator 130 may identify data associated with execution of the toolbar, and provide the second packaged application 150 using the data associated with executing the selected subset of user-interface elements to another device (e.g., a tablet or laptop computer). The toolbar of the second packaged application 150 may be executed on the other device (e.g., the tablet or laptop computer) to control aspects of the first packaged application 120 running on the device 110 (e.g., the television). So, for example, a toolbar used to change volume or channels on the television may be packaged into the second packaged application 150 and executed on another device to control the television. The above examples are for illustrative purposes and are not intended to limit the scope of the disclosure. Other uses may be contemplated.

As previously described, the sub-module generator 130 may identify and select permissions, one or more entry points, and code and resources associated with execution of the selected subset of user-interface elements. The sub-module generator 130 may isolate particular sections of code and resources associated with execution of the selected subset of user-interface elements. In some embodiments, the sub-module generator 130 may use an iterative process to isolate sections of the code and resources associated with execution of the selected subset of user-interface elements, including, in some examples, functions and libraries associated with execution of the selected sub-set of user interface elements. In some embodiments, the sub-module generator 130 may use a code splitter process described in U.S. patent application Ser. No. 13/988,417, which application is incorporated by reference herein in its entirety and for any purpose.

For example, a process for extracting code or resources of the first packaged application 120 associated with execution of the selected subset of user interface elements may be performed by the sub-module generator 130, and may include selecting a previously-unselected portion of code and/or resources for removal. In some embodiments, the selection may be performed by decomposing the first packaged application 120 into a hierarchical tree, where each portion of the tree may correspond to one or more user interface elements. individual portions of the tree may have predicted impacts on execution of the selected subset of user interface elements if removed, and the selection may be based on an iterative search through some portions or all of the tree. In some embodiments, each content source portion may be associated with a probability of need (i.e., the probability that the portion is required for execution of the selected subset of user interface elements) and/or a priority of removal (i.e., how important it is that the portion is removed to isolate code and resources associated with the selected subset of user interface elements).

The process may further include generating a version of the second packaged application 150, and examining the version of the second packaged application 150 to determine whether execution of the selected subset of user interface elements has been damaged. For example, it may be determined that the appearance and/or functionality associated with execution of the selected subset of user interface elements has been altered. if the selected subset of user interface elements has been damaged, presumably by the removal of the portion of the code and/or resources, the removed portion of the code and/or resources may be restored, and a new, previously-unselected portion of the code and/or resources may be selected for removal.

If execution of the selected subset of user interface elements that are selected for extraction has not been damaged, it may be determined, whether the selected subset of user-interface elements have been sufficiently isolated. For example, it may be determined whether other, non-selected user-interface elements or content still appear. If the selected subset of user interface elements are not sufficiently isolated, another previously-unselected portion of the code or resources may be selected for removal, and the process of creating another version of the second packaged application 170 may be performed. However, if the selected subset of user-interface elements have been sufficiently isolated, the extraction process may be deemed complete. Extracting only the code and resource elements that are associated with execution of the selected subset of user-interface elements may result in the second packaged application 150 being smaller in size and complexity than the first packaged application 120.

In some examples, two or more second packaged applications 150 may be generated from the first packaged application 120. The two or more second packaged applications 150 may share common elements (e.g., code and/or resources such as libraries, functions, etc.). Thus, when generating the second packaged application 150, the sub-module generator 130 may use a hierarchical referencing approach such that a single copy of these common elements may be stored at a higher level and the second packaged application 150 includes references back to the single copy of common elements Recombining two or more of packaged applications, including the second packaged application 150, having references to the higher level common elements may reduce or eliminate duplication of common code and/or resources in the recombined packaged application.

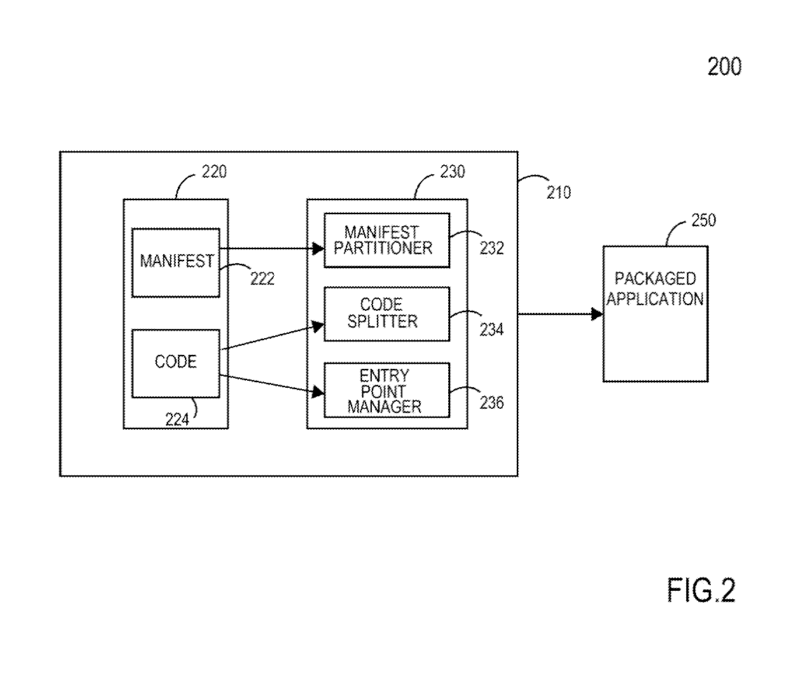

FIG. 2 is a schematic illustration of an apparatus 200 including a sub-module generator configured to provide a packaged application, arranged in accordance with at least some embodiments described herein, FIG. 2 depicts a device 210 that may include a first packaged application 220 and a sub-module generator 230. The sub-module generator 230 may provide a second packaged application 250 based on a received selection of a subset of user-interface elements of the first packaged application 220. The device 210 may be used to implement the device 110 of FIG. 1. The device 210 may include a communications device, a personal digital assistant (PDA), a fixed location data unit, a mobile location data unit, a mobile phone, a cellular phone, a computer, a portable computer, a desktop computer, a monitor, a computer monitor, a television, a digital music player, a portable music player, a video player, a digital video player, or any other electronic device. The various components described in FIG. 2 are merely examples, and other variations, including eliminating components, combining components, and substituting components are all contemplated.

The first packaged application 220 may operate on a designated operating system platform of the device 210. In some examples, the first packaged application 220 may be a packaged web application that is designed to operate using a web browser application as an operating system platform. In some embodiments, the first packaged application 220 may be integrated with the operating system of the device 210. The first packaged application 220 may be designed to operate offline (e.g., with no connectivity to the Internet or other network) and/or online. The first packaged application 220 may include a manifest 222 and code 224.

The manifest 222 may include meta information, such as information that designates portions of an operating system or components of the device 210 to which the first packaged application 220 needs access in order to properly execute. For example, the manifest 222 may designate permissions necessary to execute the first packaged application 220, such as browser permissions or underlying operating system permissions. Defining permissions in the manifest 222 may increase a level of security associated with the first packaged application 220 by preventing another application from using the first packaged application 220 as a conduit to gain access to portions of the device 210 to which the first packaged application 220 does not have access. For example, if the first packaged application 220 does not have permission to access system memory, another application would not be able to use the first packaged application 220 to gain access to system memory.

The code 224 may include source code, libraries, and other references necessary to execute the first packaged application 220. The code 224 may define user interface elements to be displayed h the operating system platform. The code 224 may also include data related to user-interface element code entry points. Entry points may define where the code 224 is entered when the first packaged application 220 is launched (e.g., opened), installed, or suspended (e.g., closed or shut down).

The sub-module generator 230 may receive a selected subset of user interface elements of the first packaged application 220, and may identify data of the first packaged application 220 associated with execution of the selected subset of user-interface elements. The sub-module generator 230 may use the identified data to provide the second packaged application 250, which may generate and execute the selected subset of user-interface elements. The selection of the user-interface elements may be received via an 110 component of the device 210. The selection of the user-interface elements may be made by a user, including another computer process. The sub-module generator 230 may include a manifest partitioner 232 to identify meta information from the manifest 222 (e.g., access permissions) that is associated with execution of the subset of use elements. For example this may be done by evaluating, the access needed by the code identified for the sub-module. The sub-module generator 230 may also include an entry-point manager 236 that identifies entry point of the code 224 associated with execution of the subset of user-interface elements, and a code splitter 234 that identifies portions of the code 224 (e.g., modules, libraries, etc.) associated with execution of the subset of user-interface elements.

In operation, the sub-module generator 230 may receive a selection of a subset of user-interface elements of the first packaged application 220 to be provided in a packaged application (e.g., the second packaged application 250). The selected subset of user-interface elements may be received based on a selection by a user. The sub-module generator 230 may identify data of the first packaged application 220 that is associated with execution of the subset of user-interface elements, and provide the second packaged application 250 based on the data, In some examples, the second packaged application 250 may be provided to another device, and may run as a stand-alone packaged application. In other examples, the second packaged application 250 may operate on another device and interface back via a network (e.g., or other interface) connection to the device 210 to control aspects of the first packaged application 220. Other uses may be contemplated.

As previously described, the manifest partitioner 232 may identify meta information in the manifest 222, and the entry-point manager 236 and the code splitter 234 may identify entry point data, and code and resources of the code 224, respectively, associated with execution of the selected subset of user-interface elements. The manifest partitioner 232 identifying the meta information of the manifest 222 may include selection of permissions, icons, text name, and other relevant information associated with execution of the selected subset of user-interface elements. For example, the selected subset of user-interface elements may only require a subset of permissions included in the manifest 222 and used by the first packaged application 220. The manifest partitioner 232 may extract the subset of permissions from the manifest 222 to be included in the data. In some embodiments, the manifest 212 may be an extensible markup language (XML) file, and the manifest partitioner 232 may be capable of extracting information from the XML file, and reproducing another manifest in the form of an XML file to be included in the second packaged application 250.

The entry-point manager 236 may identify one or more entry points associated with the selected subset of user-interface elements. As previously described, the code entry points may include entry points included in the code 224 that are associated with launching the first packaged application 220, installing or uninstalling the first packaged application 220, and/or suspending or closing the first packaged application 220, in some examples. Execution of the selected subset of user-interface elements may only include a subset of entry points of the code 714.

The code splitter 234 may identify code and resources associated with executing the selected subset of user-interface elements. The code splitter 234 may isolate particular sections of code 224 associated with execution of the selected subset of user-interface elements. In some embodiments, the code splitter 234 may use an iterative process to isolate sections of the code 224 associated with execution of the selected subset of user-interface elements.

For example, extraction of the code 224 from the first packaged application 220 that is associated with execution of the selected subset of user interface elements may include the code splitter 234 performing a selection of a previously-unselected portion of the code 224 for removal. In some embodiments, the selection may be performed by decomposing the code 224 into a hierarchical tree, where each portion of the tree may correspond to one or more user interface elements. Individual portions of the tree may have predicted impacts on execution of the selected subset of user interface elements if removed, and the selection may be based on an iterative search through the tree. In some embodiments, each content source portion may be associated with a probability of need (i.e., the probability that the portion is required for execution of the selected subset of user interface elements) and/or a priority of removal (i.e., how important it is that the portion is removed to isolate the code 224 associated with the selected subset of user interface elements).

The code splitter 234 may generate a version of the second packaged application 250, and examine the version of the second packaged application 250 to determine whether execution of the selected subset of user interface elements has been damaged. For example, the code splitter 234 may determine whether the appearance and/or functionality associated with execution of the selected subset of user interface elements has been altered. if the selected subset of user interface elements has been damaged, presumably by the removal of the portion of the code 224, the code splitter 234 may restore the removed portion of the code 224, and may select a different, previously-unselected portion of the code 224 for removal.

If execution of the selected subset of user interface elements that are selected for extraction has not been damaged, the code splitter 234 may determine whether the selected subset of user-interface elements have been sufficiently isolated. For example, the code splitter 234 may determine whether other, non-selected user-interface elements or content still appear. If the selected subset of user interface elements are not sufficiently isolated, the code splitter 234 may select another previously-unselected portion of the code 224 for removal, and the code splitter 234 may generate another version of the second packaged application 250 to see if the newly removed portion of the code 224 affected execution of the selected subset of user-interface elements. The code splitter 234 may continue the process until it is determined that the selected subset of user-interface elements have been sufficiently isolated. Extracting only the code and resource elements that are associated with execution of the selected subset of user-interface elements may result in the second packaged application 250 being smaller in size and complexity than the first packaged application 220.

In some examples, the first packaged application 220 may include an observer pattern programming approach. For example, one part of the first packaged application 220 may publish messages for consumption by another part of the first packaged application 220. The publish and subscribe system may be handled by libraries and application program interfaces (API) supported by the host application executables and/or the operating system. This may be relevant as published and/or subscribed messages associated with the selected subset of user-interface elements may be dependent on subscribed and/or published messages of other parts of the first packaged application 220 not associated with the selected subset of user-interface elements. Thus, the code splitter 234 may also flag publish and subscribe messages associated with the selected subset of user-interface elements. In some examples, the sub-module generator 230 may escalate the publish and subscribe messages to be remotely handled (e.g., via a network server) publish and subscribe messages. For example, the code splitter 234 may replace the publish library with a cloud callback handler, and the publish/subscribe handling may be replaced with the cloud callback handler. In other embodiments, the publish/subscribe messaging may be replaced by the sub-module generator 230 with a locally-handled message structure to, for example, be used in application that want to avoid dependency on network access.

In some embodiments, the sub-module generator 230 may receive two or more packaged applications including the second packaged application 250 and re-assemble the first packaged application 220 or portions of the first packaged application 220. Each received second packaged application may be associated with a different selected subset of user-interface elements, When generated, each of the two or more second packaged applications including the second packaged application 250 may include duplicated code and/or resources that were shared in the first packaged application 220, but needed to be included in each of the two or more of the second packaged applications 250 to allow each of the two or more of the second packaged applications 250 to operate as stand-alone packaged applications. Thus, to avoid duplicating common elements, the code splitter 234 may use a hierarchical referencing approach when generating the second packaged application 250 such that a single copy of common elements (e.g., common code and/or resources) are stored at a higher level and the second packaged application 250 includes references back to the single copy of common elements. Recombining the two or more of the second packaged applications, including the second packaged application 250, having references to the higher level computing elements may reduce or eliminate duplication of common code and/or resources in the recombined packaged application.

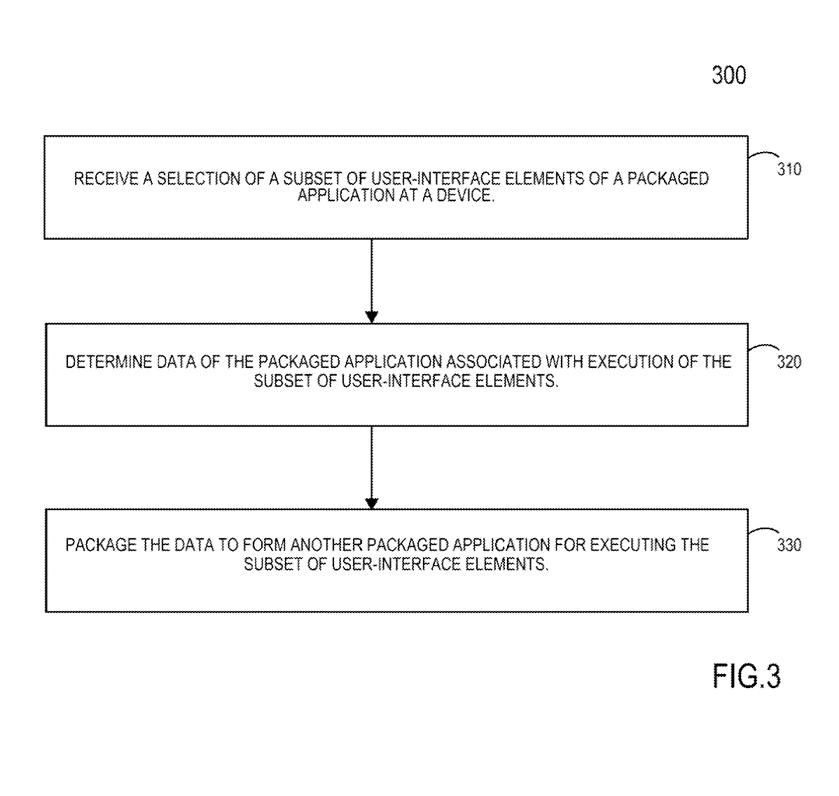

FIG. 3 is a flowchart illustrating an example method 300 for providing a second packaged application based on a selection of a subset of user-interface elements of a first packaged application. An example method 300 may include one or more operations, functions or actions as illustrated by one or more of blocks 310, 320, and 330. The operations described in the blocks 310 through 330 may be performed in response to execution (such as by one or more processors described herein) of computer-executable instructions stored in a computer-readable medium, such as a computer-readable medium of a computing device or sonic other controller similarly configured.

An example method (e.g., process) 300 may begin with block 310, which recites “receive a selection of a subset of user-interface elements of a packaged application at a device”. Block 310 may be followed by block 320, which recites “determine data of the packaged application associated with execution of the subset of user-interface elements.” Block 320 may be followed by block 330, which recites “package the data to form another packaged application for executing the subset of user-interface elements.”

The blocks included in the described example methods are for illustration purposes. In some embodiments, the blocks may be performed in a different order. In some other embodiments, various blocks may be eliminated. In still other embodiments, various blocks may be divided into additional blocks, supplemented with other blocks, or combined together into fewer blocks. Other variations of these specific blocks are contemplated, including changes in the order of the blocks, changes in the content of the blocks being split or combined into other blocks, etc.

Block 310 recites, “receive a selection of a subset of user-interface elements of a packaged application at a device.” The device may include the device 110 of FIG. 1 and/or the device 210 of FIG. 2, or another device, The subset of user-interface elements may be selected by a user of the device. The packaged application may include the first packaged application 120 of FIG. 1 and/or the first packaged application 220 of FIG. 2.

Block 320 recites, “determine data of the packaged application associated with execution of the subset of user-interface elements.” The data may be determined by a sub module generator, such as the sub-module generator 130 of FIG. 1 and/or the sub-module generator 230 of FIG. 2, The method 300 may further include selecting permissions associated with executing the subset of user-interface elements. The permissions may be selected from a manifest, such as the manifest 222 of FIG. 2. In some embodiments, the permissions may include input/output device access, memory write access, network access, interne access, or combinations thereof.

The method 300 may further include isolating portions of source code to identify functions and libraries of the source code that are associated with execution of the subset of user-interface elements. The method 300 may further include selecting, for inclusion in the data, functions and libraries that are identified as being associated with execution of the subset of user-interface elements. In some embodiments, isolation of portions of the source code and selection of the functions and libraries may be performed by the code splitter 234 of FIG. 2.

The method 300 may further include selecting packaged application entry points associated with execution of the subset of user-interface elements. En some embodiments, selection of the packaged application entry points may be performed by the entry-point manager 236 of FIG. 2.

Block 330 recites, “package the data to form another packaged application for executing the subset of user-interface elements.” in some embodiments, the other packaged application may be packaged by a sub-module generator, such as the sub-module generator 130 of FIG. 1 and/or the sub-module generator 230 of FIG. 2. The method 300 may further include providing the another packaged application to a second device. In some embodiments, the method 300 may further include receiving commands from the another packaged application running on the second device, and updating user-interface elements of the packaged application running on the device responsive to the received commands.

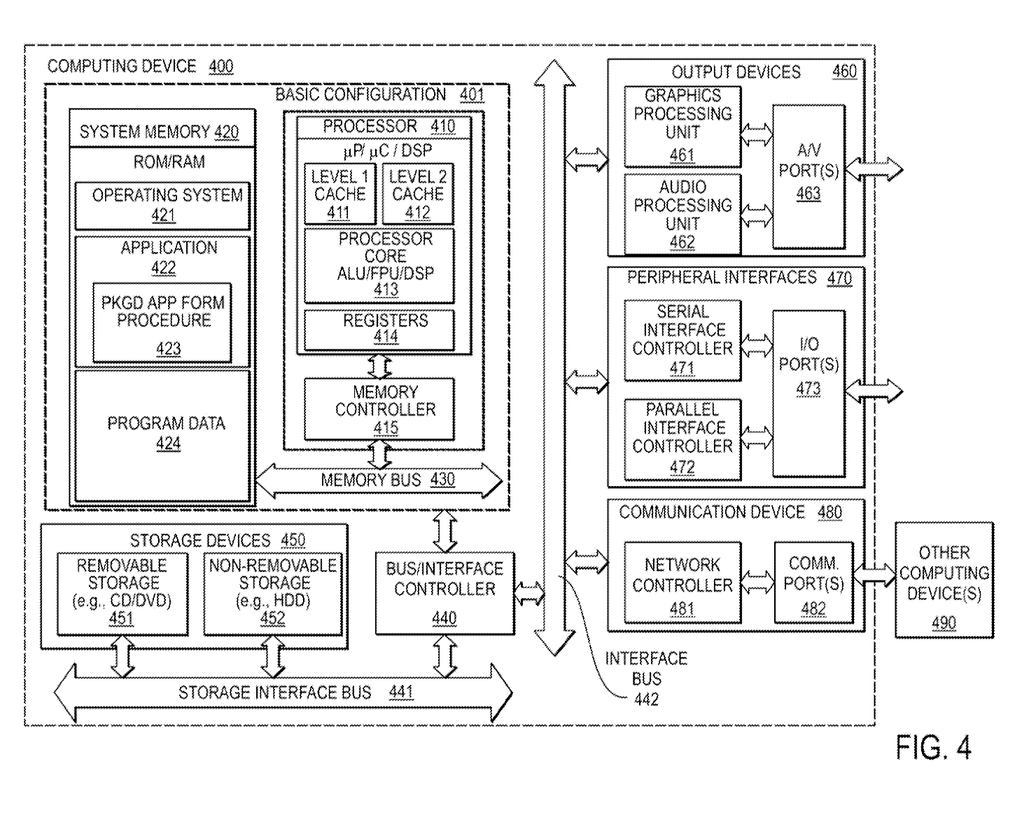

FIG. 4 is a block diagram illustrating an example computing, device 400 that is arranged for positioning nanostructures in accordance with the present disclosure. In a very basic configuration 401, computing device 400 typically includes one or more processors 410 and system memory 420. A memory bus 430 may be used for communicating between the processor 410 and the system memory 420. The computing device 400 may be used to implement the device 110 of FIG. 1 and/or the device 210 of FIG. 2.

Depending on the desired configuration, processor 410 may be of any type including but not limited to a microprocessor (μP), a microcontroller (μC), a digital signal processor (DSP), or any combination thereof Processor 410 may include one more levels of caching, such as a level one cache 411 and a level two cache 412, a processor core 413, and registers 414. An example processor core 413 may include an arithmetic logic unit (ALU), a floating point unit (FPU), a digital signal processing core (DSP Core), or any combination thereof. An example memory controller 415 may also be used with the processor 410, or in some implementations the memory controller 415 may be an internal part of the processor 410.

Depending on the desired configuration, the system memory 420 may be of any type including, but not limited to volatile memory (such as RAM), non-volatile memory (such as ROM, flash memory, etc.) or any combination thereof. System memory 420 may include an operating system 421, one or more applications 422, and program data 424. Applications 422 may include a packaged application formation procedure 423 that is arranged to form a packaged application based on a selected subset of user-interface elements, as described herein. The packaged application formation procedure 423 may include the sub-module generator, such as the sub-module generator of FIGS. 1 and 2. The applications 422 may further include the code splitter or other applications described herein. Program data 424 may include data regarding selected user interface elements, entry points, code features, and/or other information useful for the implementation of the method of forming, a packaged application based on a selected subset of user-interface elements. In some embodiments, application 422 may be arranged to operate with program data 424 on an operating system 421 such that any of the procedures described herein may be performed. This described basic configuration is illustrated in FIG. 4 by those components within dashed line of the basic configuration 401.

Computing device 400 may have additional features or functionality, and additional interfaces to facilitate communications between the basic configuration 401 and any required devices and interfaces. For example, a bus/interface controller 440 may be used to facilitate communications between the basic configuration 401 and one or more storage devices 450 via a storage interface bus 441. The storage devices 450 may be removable storage devices 451, non-removable storage devices 452, or a combination thereof. Examples of removable storage and non-removable storage devices include magnetic disk devices such as flexible disk drives and hard-disk drives (HDD), optical disk drives such as compact disc (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 420, removable storage devices 451 and non-removable storage 452 are all examples of computer storage media. Computer storage media includes, but is not limited to, RAM, ROM, EEPROM, flash memory or other memory technology, CD-ROM, digital versatile disks (DV D) or other optical storage, magnetic cassettes, magnetic tape, magnetic disk storage or other magnetic storage devices, or any other medium which may be used to store the desired information and which may be accessed by computing device 400. Any such computer storage media may be pan of computing device 400.

Computing device 400 may also include an interface bus 442 for facilitating communication from various interface devices (e.g., output interfaces, peripheral interfaces, and communication interfaces) to the basic configuration 401 via the bus/interface controller 440. Example output devices 460 include a graphics processing unit 461 and an audio processing unit 462, which may be configured to communicate to various external devices such as a display or speakers via one or more A/V ports 463. Example peripheral interfaces 470 include a serial interface controller 471 or a parallel interface controller 472, which may be configured to communicate with external devices such as input devices (e.g., keyboard, mouse, pen, voice input device, touch input device, etc.) or other peripheral devices (e.g., printer, scantier, etc.) via one or more I/O ports 471 An example communication device 480 includes a network controller 4, which may be arranged to facilitate communications with one or more other computing devices 490 over a network communication link via one or more communication ports 482.

The network communication link may be one example of a communication media. Communication media may typically be embodied by computer readable instructions, data structures, program modules, or other data in a modulated data signal, such as a carrier wave or other transport mechanism, and may include any information deliver media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal digital assistant (PDA), a personal media player device, a wireless web-watch device, a personal headset device, an application specific device, or a hybrid device that may include any of the above functions. Computing device 400 may also be implemented as a personal computer including. both laptop computer and non-laptop computer configurations.

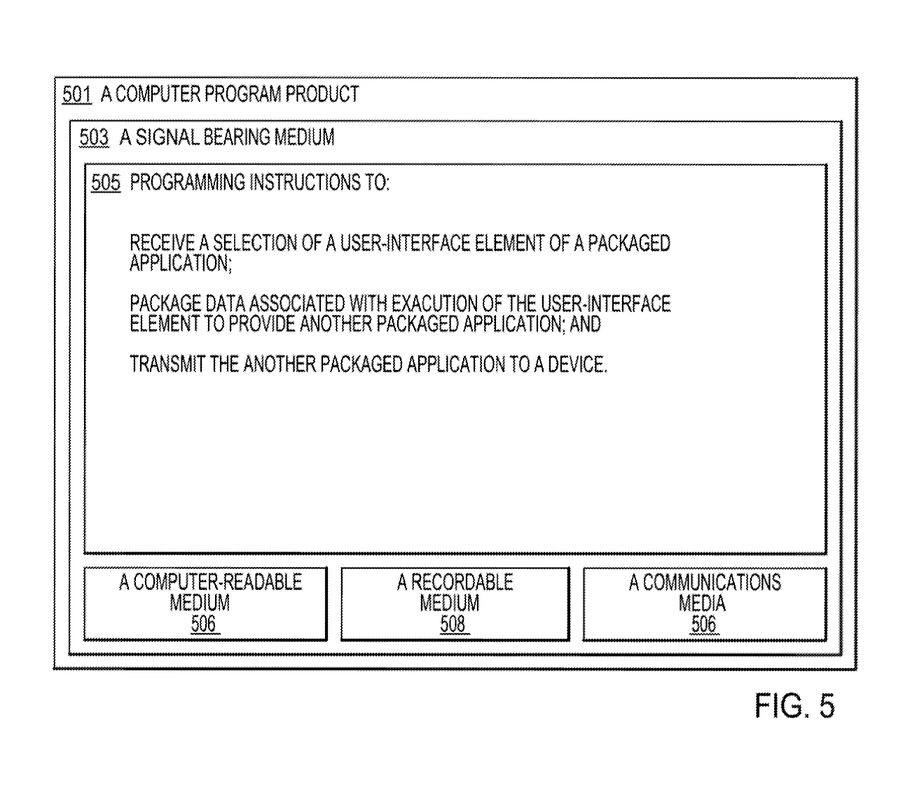

FIG. 5 is a block diagram illustrating an example computer program product 500 that is arranged to store instructions for forming a packaged application based on a selected subset of user-interface elements in accordance with the present disclosure. The signal bearing medium 502 which may be implemented as or include a computer-readable medium 506, a computer recordable medium 508, a computer communications medium 510, or combinations thereof, stores programming instructions 504 that may configure the processing unit to perform all or some of the processes previously described. These instructions may include, for example, one or more executable instructions for causing “the one or more processing units to perform actions, including receiving a selection of a user-interface element of a packaged application.” The instructions may further include, for example, one or more executable instructions for causing the one or more processing units to perform actions including “packaging data associated with execution of the user interface element to provide another packaged application.” The instructions may further include, for example, one or more executable instructions for causing the one or more processing units to perform actions including “transmitting the another packaged application to a device.”

The present disclosure is not to be limited in terms of the particular examples described in this application, which are intended as illustrations of various aspects. Many modifications and examples can be made without departing, from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and examples are intended to fall within the scope of the appended claims. The present disclosure is to be binned only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular examples only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together. etc). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should he understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art, all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

While the foregoing detailed description has set forth various examples of the devices and/or processes via the use of block diagrams, flowcharts, and/or examples, such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one example, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the examples disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. For example, if a user determines that speed and accuracy are paramount, the user may opt for a mainly hardware and/or firmware vehicle; if flexibility is paramount, the user may opt for a mainly software implementation; or, yet again alternatively, the user may opt for some combination of hardware, software, and/or firmware.

In addition, those skilled in the art will appreciate that the mechanisms of the subject matter described herein are capable of being distributed as a program product in a variety of forms, and that an illustrative example of the subject matter described herein applies regardless of the particular type of signal bearing, medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium a fiber optic cable, a waveguide, a wired communications link, a wireless communication link, etc.).

Those skilled, in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving, and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While various aspects and examples have been disclosed herein, other aspects and examples will be apparent to those skilled in the art. The various aspects and examples disclosed herein are for purposes of illustration and are not intended to be limiting, with the true scope and spirit being indicated by the following claims.

1. An apparatus comprising:
a packaged application including user-interface elements; and
a sub-module generator configured to receive a selection of a subset of the user-interface elements, the sub-module generator configured to identify data of the packaged application associated with execution of the subset of user-interface elements, the sub-module generator further configured to generate another packaged application for execution of the selection of user-interface elements using the data.

2. The apparatus of claim 1, wherein the sub-module generator is further configured to identify one or more entry points of the packaged application associated with execution of the subset of user-interface elements, wherein the sub-module generator is further configured to provide the one or more entry points for inclusion in the data.

3. The apparatus of claim 2, wherein the entry points include an entry point associated with launching the packaged application, an entry point associated with installing the packaged application, an entry point associated with suspending the packaged application, or combinations thereof.

4. The apparatus of claim 1, wherein the sub-module generator is further configured to identify meta information associated with execution of the subset of user-interface elements, the sub-module generator further configured to provide the identified meta information for inclusion in the data.

5. The apparatus of claim 4, wherein the sub-module generator is further configured to select permissions associated with execution of the subset of user-interface elements to be included in the identified.

6. The apparatus of claim 4, wherein the sub-module generator is further configured to select an icon associated with execution of the subset of user-interface elements to be included in the identified.

7. The apparatus of claim 1, wherein the sub-module generator is further configured to iteratively identify portions of code of the packaged application associated with execution of the subset of user-interface elements, the sub-module generator further configured to provide the portions of the code for inclusion in the data.

8. The apparatus of claim 7, wherein the sub-module generator configured to iteratively identify portions of code of the packaged application associated with execution of the subset of user-interface elements includes identification of functions and libraries associated with execution of the subset of user-interface elements.

9. The apparatus of claim 1, wherein sub-module generator is further configured to escalate locally handled publish and subscribe messages associated with execution of the subset of user-interface elements to remotely handled publish and subscribe messages.

10. A non-transitory computer-readable medium comprising instructions that, when executed by one or more processing units, cause the one or more processing units to perform actions including:
receiving a selection of a user-interface element of a packaged application;
packaging data associated with execution of the user-interface element to provide another packaged application; and
transmitting the another packaged application to a device.

11. The non-transitory computer-readable medium of claim 10, wherein packaged application includes a plurality of distributed user interface (DUI) modules, the non-transitory computer-readable medium further comprising instructions that when executed cause the one or more processing units to perform actions including selecting one or more DUI modules of the plurality of DUI modules associated with execution of the user-interface element.

12. The non-transitory computer-readable medium of claim 11, wherein the packaged application further includes a common element referenced by two or more of the plurality of DUI modules, wherein the common element is stored at a higher level than the plurality of DUI modules, the non-transitory computer-readable medium further comprising instructions that when executed cause the one or more processing units to perform actions including resolving references to the common element within the selected one or more DUI modules responsive the selected one or more DUI modules including at least one of the two or more of the plurality of DUI modules that reference the common element.

13. The non-transitory computer-readable medium of claim 10, further comprising instructions that when executed cause the one or more processing units to perform actions including:
selecting, for inclusion in the data, portions of code of the packaged application that are associated with execution of the user-interface element;
selecting, for inclusion in the data, entry points associated with execution of the user-interface element; and
selecting, for inclusion in the data, meta data associated with execution of the user-interface element, wherein the meta data includes permissions data.

14. A method, comprising:
receiving a selection of a subset of user-interface elements of a packaged application at a device;
determining data of the packaged application associated with execution of the subset of user-interface elements; and
packaging the data to form another packaged application for executing the subset of user-interface elements.

15. The method of claim 14, further comprising selecting permissions associated with executing the subset of user-interface elements.

16. The method of claim 15, wherein the permissions includes input/output device access, memory write access, network access, internet access, or combinations thereof.

17. The method of claim 14, further comprising:
isolating portions of source code to identify functions and libraries of the source code that are associated with execution of the subset of user-interface elements; and
selecting, for inclusion in the data, functions and libraries that are identified as being associated with execution of the subset of user-interface elements.

18. The method of claim 14, further comprising selecting packaged application entry points associated with execution of the subset of user-interface elements.

19. The method of claim 14, further comprising providing the another packaged application to a second device.

20. The method of claim 19, further comprising;
receiving commands from the another packaged application running on the second device; and
updating user-interface elements of the packaged application running on the device responsive to the received commands.
